(19) United States
(12) Patent Application Publication
(10) Pub. No.: US 2026/0051181 A1
(43) Pub. Date: Feb. 19, 2026

(54) APPARATUS

(71) Applicant: EXA ROBOTIC SYSTEMS LTD, Daresbury (GB)

(72) Inventors: Lisa Layzell, Jr., Manchester (GB); Paolo Paoletti, Manchester (GB); Sebastiano Fichera, Manchester (GB)

(21) Appl. No.: 19/103,967

(22) PCT Filed: Aug. 14, 2023
(86) PCT No.: PCT/GB2023/052140

§ 371 Date: Feb. 14, 2025

(30) Foreign Application Priority Data
Aug. 15, 2022 (GB) 2211903.6

(51) Int. Cl. G06V 20/56; G01S 17/89; G06T 7/00; G06V 10/147; G06V 10/764

(52) U.S. Cl. CPC G06V 20/588; G01S 17/89; G06T 7/0002; G06V 10/147; G06V 10/764; G06T 2207/10024; G06T 2207/10028; G06T 2207/30256

(57) ABSTRACT

The present disclosure relates to an apparatus (100) for capturing information on roadway surfaces (10) and a server (200) configured to analyse that data. The apparatus (100) comprises a mount (102) to attach the apparatus (100) to a vehicle (20), a set of sensors (104) configured to capture data relating to the roadway surface (10) proximate to the vehicle (20) during locomotion of the vehicle (20), and a communicator (120) configured to transmit the captured data relating to the roadway surface (10) to the server (200), via a telecommunications network, while the vehicle (20) is in operation. The first sensor comprises a laser profilometer comprising a scanning laser (114) and an image sensor (116), and wherein the data relating to the roadway surface (10) includes laser profilometry data of the roadway surface (10).

### FIELD OF THE INVENTION

The present disclosure relates to an apparatus for capturing information on roadway surfaces and method(s) for identifying and reporting on roadway defects using a corresponding analysis server.

### BACKGROUND

In the UK, more than 2 million potholes in roads are repaired annually at a cost of about £120 million. However, damage to vehicles caused by potholes in the UK is estimated to cost in excess of £1 billion annually. In addition, the number of reported cyclists serious and fatal injuries in the UK where poor defective road surface is reported as a contributory factor has increased linearly between 2007 and 2017 from 17 to 64 cyclists.

Typically, a pothole is hole or a depression in a road surface that results from gradual damage caused by traffic and/or weather. A pothole may be defined more specifically as a cavity in a road, footpath, or cycle route, having a depth of at least 25 mm or at least 40 mm, though potholes are typically only repaired when reaching a depth of at least 60 mm. Cost of repair and potential damage to vehicles increases with depth. Nevertheless, around 90% of potholes are in the top wearing course. Earlier remediation may reduce cost of repair and potential damage to vehicles.

In the UK, potholes are typically identified by members of the public and reported to a relevant local highway authority. However, smaller potholes and/or defects in a road surface (e.g., less than 25 mm depth) may easily get missed, or may be deemed to be too small to worry about (many people have a default disposition to ‘not cause a fuss’), and therefore not reported to a relevant authority. Over time these apparently minor road surface defects continue to worsen until they are (finally) identified, all the while continuing to cause damage until they are eventually repaired. Earlier repair however could have avoided some of the repair cost to the road and to vehicle damage.

Recently, devices have started to be proposed which remove the human component from identifying road conditions. For example, in the related art US 2016/0177524 discusses a street sweeper fitted with a lidar device which may be used to collect data for road condition analysis. A limitation of lidar is that it is only useful for determining large scale road defects, being unable to provide sufficient data points to achieve high enough resolution for small road defects (e.g., thin cracks), and cannot do so with any accuracy while a vehicle is moving at speed (not least due to e.g., vibrations of the vehicle).

Hence, there is a desire to improve upon the current techniques automatic identification of road defects for subsequent repair.

### SUMMARY

The present invention is defined according to the independent claims. Additional features will be appreciated from the dependent claims and the description herein. Any embodiments which are described but which do not fall within the scope of the claims are to be interpreted merely as examples useful for a better understanding of the invention.

The example embodiments have been provided with a view to addressing at least some of the difficulties that are encountered with current techniques for pothole identification, whether those difficulties have been specifically mentioned above or will otherwise be appreciated from the discussion herein. For instance, it is an aim of embodiments of the present disclosure to provide an improved technique for identifying road defects.

Accordingly, in one aspect of the present disclosure there is provided an apparatus for capturing information on roadway surfaces. The apparatus comprises a mount to attach the apparatus to a vehicle, a set of sensors (including a first sensor) configured to capture data relating to the roadway surface (proximate to the vehicle) during locomotion of the vehicle, and a communicator configured to transmit the captured data relating to the roadway surface to a remote server, via a telecommunications network (such as 4G or 5G networks), in substantially real time (i.e., while the vehicle is in operation).

Suitably the present apparatus is useable with, and interchangeable between, a range of vehicles comprising suitable mounting means which cooperate with the apparatus mount, so that the apparatus may perform its function of collecting road data while the vehicle is in use. While the vehicle may be one which is dedicated to the task of collecting roadway data, it is particularly envisaged that the apparatus is mounted to vehicles for which their primary role is not road surface survey, but rather such surveying becomes a secondary function of the vehicle once the apparatus is mounted. Envisaged primary roles of the vehicle include e.g., general purpose highway maintenance, deliveries, taxiing, road network mapping, etc. Suitably, data collected by the apparatus is transmitted to a server for analysis while the vehicle is in operation (i.e., driving around) to provide real time, or at least near real time, updates which may be similarly analysed in real (or near real) time in order to provide live updates to a roadway defect reporting service. The wireless transmission of the data also facilitates the apparatus being used on non-dedicated pothole maintenance vehicles by providing means for data to be uploaded for analysis without requiring dedicated maintenance personnel to manually extract data from the apparatus.

A first sensor of the set of sensors may comprise and/or may be a laser profilometer (configured to scan the road near the vehicle, preferably in front or behind with respect to the direction of travel). Laser profilometry provides high resolution scans of the road in order to reveal even small cracks which might be suitable for repair, in addition to being usable at a pulse frequency, wavelength (preferably near infra-red), and power (e.g., 2 Watts) which allow for high quality data capture but also safe data capture. Laser profilometry therefore represents a significant improvement over other ranging techniques, such as lidar, due to the improved resolution that is possible. Also, although laser profilometry is a known technique in other fields, existing profilometers are not suitable for roadway use, instead having been developed for indoor use in highly controlled environments such as assembly and quality control lines. By contrast, the laser profilometry technique discussed herein is appropriate for use while a vehicle is travelling at speed (e.g., 10 mph, 20 mph, 30 mph, or even 60 mph) while still producing high resolution data, which again is not possible using existing lidar (or other) approaches to road condition analysis.

A second sensor of the set of sensors may comprise and/or may be a colour image sensor (preferably aligned to capture an image mutually corresponding to the field of view of the first sensor/profilometer), a third sensor of the set of sensors may comprise and/or may be a global positioning system ‘GPS’, and a fourth sensor of the set of sensors may comprise and/or may be an inertial measurement unit ‘IMU’. Each sensor in the set may provide data relating to the roadway surface which is either analysable (either alone or in combination with other sensor data) to identify a surface defect on a given stretch of road and/or determining parameters relating to the defect—optionally including one or a combination of physical parameters (e.g., dimensions such as length, width, depth) and also subjective parameters such as severity—and/or also reporting on the identified defect and its associated parameters. This combination of data collection allows for far improved defect analysis and identification than could be achieved by any one sensor alone.

In a related aspect of the present disclosure the apparatus also comprises a memory and processor configured to compile the data captured by the set of sensors into segments based on a timestamp of when the data was captured (a chunk may be further parameterised by a distance travelled by the vehicle), store the segmented data in the memory, and control the communicator to transmit each segment of data in turn based on the timestamp. The data is therefore transmitted to the server in readily readable chunks of related data, making subsequent processing considerably easier, as well as providing a suitably convenient means by which data captured by the apparatus can be queued for subsequent (near real time) transmission if the telecommunications network is being slow and/or access is limited in a particular location.

In another aspect of the present disclosure there is provided a server configured to analyse data relating to a roadway surface captured by at least one sensor of a vehicle mounted apparatus (during locomotion of the vehicle), and report detected defects of the roadway surface. The server comprises at least one communicator configured to receive, from the apparatus while the vehicle is in operation, the data relating to the roadway surface captured by the at least one sensor during locomotion of the vehicle, and configured to couple the server to a display device. The server also comprises at least one processor configured to analyse the received data relating to the roadway surface, substantially in real time as the data is received, to identify received data corresponding to a defect of the roadway, and to determine parameters of the defect based on the identified data (preferably by using a classification type machine learning model), and control the at least one communicator to transmit information related to the identified roadway defect, including the determined parameters, to the display device accessing the server. Preferably the remote coupling to the server is via the internet, such that the transmission (i.e., reporting) of the defect is achieved via a (web based) user interface which allows a user to access and view the roadway defect data stored on the server.

In a related aspect of the present disclosure, there is provided a computer implemented method for analysing and reporting defects of a roadway (the method may be performed by e.g., a server). The method comprises receiving data relating to a roadway surface captured by a set of sensors, including a first sensor, during locomotion of a vehicle to which the set of sensors are mounted, the data having been transmitted while the vehicle is in operation, then processing the received data, as it is received substantially in real time, to identify received data corresponding to a roadway defect, and determining parameters of the defect based on the identified data, and then reporting, substantially in real time, information relating to the identified defect, including the determined parameters, to a user via a user interface of a computing device. Preferably the method includes the use of a machine learning model in the step of determining the parameters of the surface defect, and may be for example a classification type machine learning model.

In a related aspect of the present disclosure there is provided a non-transitory data carrier provided with code which implements the aforementioned method.

In another aspect of the present disclosure there is provided a system comprising the aforementioned apparatus and server.

In another aspect of the present disclosure, there is provided an apparatus for capturing, analysing, and reporting defects of a roadway. The apparatus comprises a mount to attach the apparatus to a vehicle, a communicator configured to transmit data over a telecommunications network, at least one sensor configured to capture data relating to a roadway surface proximate to the vehicle during locomotion of the vehicle, and at least one processor. The processor is configured to analyse the captured data relating to the roadway surface to identify data corresponding to a defect of the roadway, and to determine parameters of the defect based on the identified data, and control the communicator to transmit, while the vehicle is in operation, information on the identified roadway defect, including the determined parameters, to a remote server.

In other words, in this alternative arrangement the apparatus is provided with suitable computing power (including, optionally, software comprising a machine learning model and further optionally dedicated hardware such as a neural processor unit) to analyse the roadway data on the apparatus so that the server does not need to perform any further processing/analysis and instead simply acts as a remote storage by which the data may be accessed and viewed.

### BRIEF DESCRIPTION OF THE DRAWINGS

For a better understanding of the present disclosure reference will now be made to the accompanying drawings, in which:

FIG. 1 shows an example apparatus mounted to a vehicle to capture information on a roadway surface;

FIG. 2 shows an example system comprising one or more apparatuses for capturing information on a roadway surface and a server to process that captured data; FIG. 2A shows example apparatuses of the system; FIG. 2B shows an example server of the system;

FIG. 3 shows an example of using laser profilometry to capture information on a roadway surface; FIG. 3A shows an example surface being scanned, FIG. 3B shows example profilometer data;

FIG. 4 shows an example speed encoder for the apparatus;

FIG. 5 shows an example user interface reporting data on determined road defects.

### DETAILED DESCRIPTION

At least some of the following example embodiments provide improved techniques for identifying and reporting on roadway defects. Many other advantages and improvements will be discussed in more detail herein.

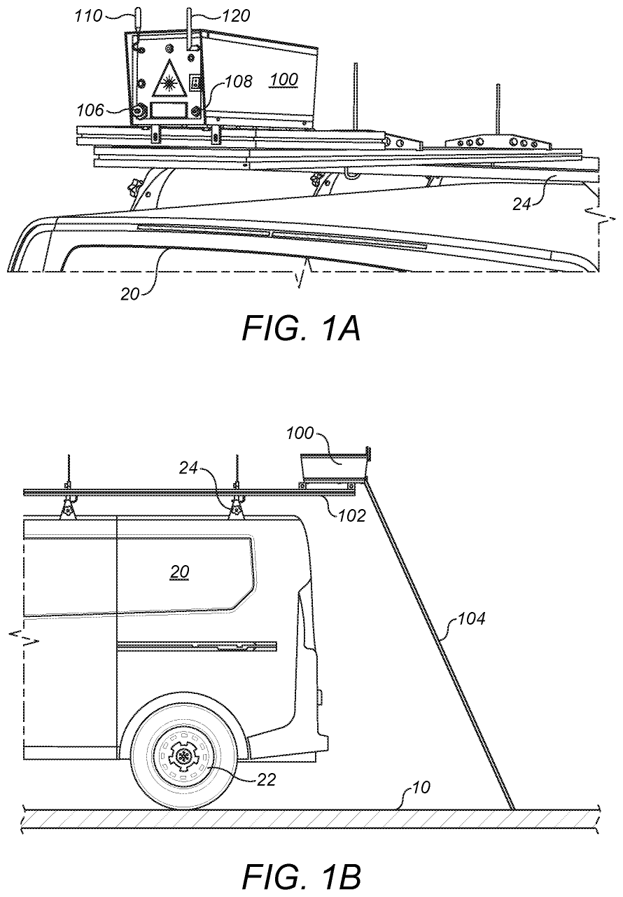

FIG. 1 shows an example apparatus 100 arranged to capture information on a roadway surface 10. Here, the roadway surface includes a surface on which a vehicle 20 is suitably arranged to travel on—e.g., in the case of a vehicle 20 which makes contact with the road surface 10, such as by one or more wheels 22—or otherwise be guided by—e.g., in the case of a flying vehicle, such as a drone, traveling above a roadway surface.

The apparatus 100 comprises a mount 102 to attach the apparatus 100 to the vehicle 20. Suitably the apparatus 100 is universal, so that it may be utilised with a wide range of vehicles. The mount 102 preferably detachably couples the apparatus 100 to the vehicle 20, so that the apparatus may be readily swapped from one vehicle to another; thus, when the apparatus 100 is deployed on one of a fleet of vehicles, it may be readily detached from a currently unused vehicle in the fleet and instead installed on an operative vehicles (or at least, one that is about to be used).

The mount 102 preferably couples the apparatus 100 to a chassis of the vehicle 20. In one example the mount 102 is configured to attach to a roof rack 24 of the vehicle 20, the roof rack typically being a substantially horizontal bar connecting a left and right of the vehicle 20 across the vehicles top; preferably the mount 102 attaches to more than one roof rack 24. In another example (not shown) the mount 102 may be configured to attach to an undercarriage of the vehicle 20.

The mount 102 allows the apparatus 100 to be positioned in a variety of different positions with respect to the vehicle, and may also comprise means to (re)position the apparatus 100 about the vehicle 20 once the mount 102 is engaged with the roof rack 24; for example, the mount 102 may comprise sliders which allow the apparatus to be moved closer to or further away from the vehicle 20. In a preferred example, the mount 102 positions the apparatus 100 extended to a rear of the vehicle 20, as shown.

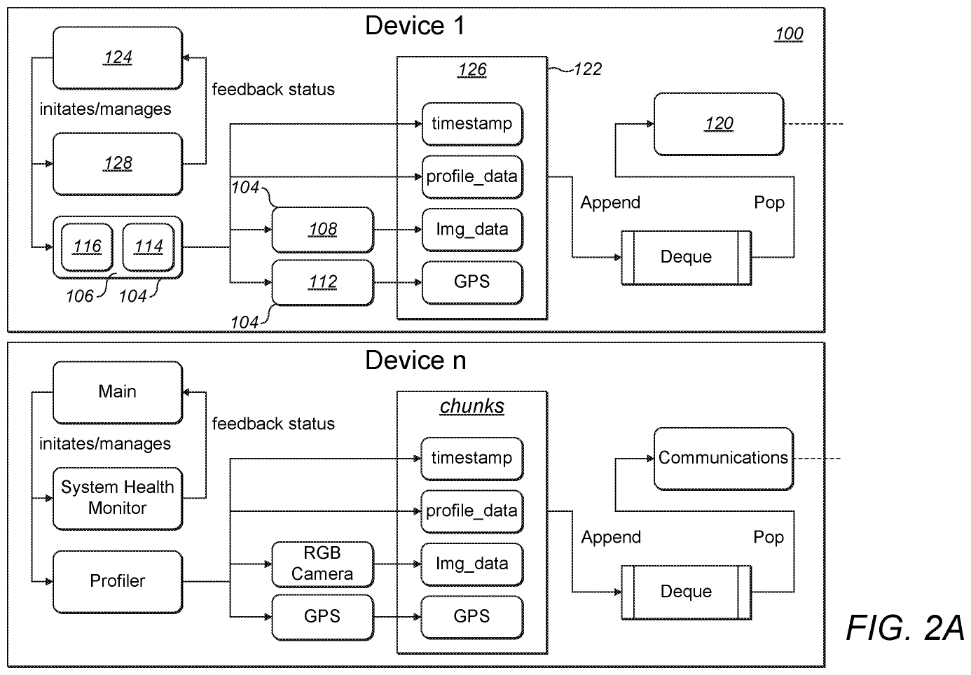

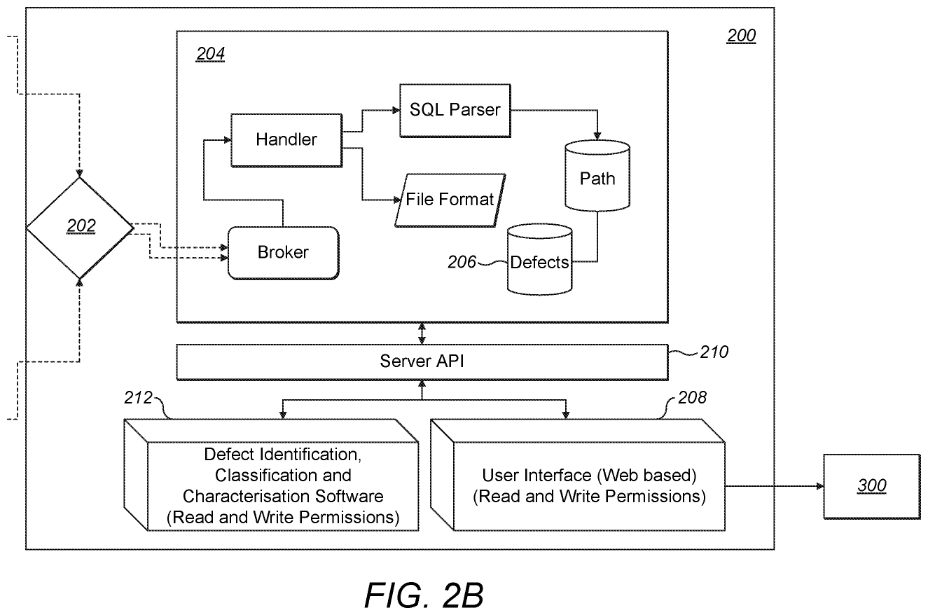

The apparatus 100 also comprises a set of sensors 104 including at least a first sensor 106. In the present examples, the set of sensors 104 also includes a second sensor 108, and third sensor 110 (see FIG. 2). Optionally, the set of sensors may further include a fourth sensor 112, and yet further sensors.

The set of sensors 104 are configured to capture data relating to the roadway surface 10 during locomotion of the vehicle 20. Suitably, information on the roadway surface, which is to be analysed to determine road defects (discussed further below) may be captured while the vehicle 20 is being driven, without (necessarily) stopping to perform a dedicated scanning task. It is particularly envisaged that the present apparatus 100 will be deployed on vehicles for which their primary role is not roadway maintenance. In this way, information on the surface state of a roadway network (or sub network thereof) may be readily gathered through the general use of vehicles on the roadway network; for example, delivery vans, council owned/operated vehicles such as refuse collectors, and so on.

The set of sensors 104 are suitably arranged to capture information on the roadway surface 10 proximate to the vehicle 20; that is, the roadway surface 10 the vehicle 20 is travelling on. In the present examples, the roadway proximate to the vehicle 20 may be taken to mean roadway up to 10 metres away from the vehicle 20 (in the plane of the roadway surface 10), more preferably up to 5 metres away from the vehicle 20, and yet further preferably up to 2 metres away from the vehicle 20 (more specifically it is the distance from the apparatus 100 and sensors 104 thereof that determines the proximate roadway).

Suitably, in one example the set of sensors 104 may be arranged to capture information on the roadway surface in front of the vehicle 20, i.e., as the vehicle is moving toward that part of the road. In another example, the set of sensors 104 may be arranged to capture information to the sides of the vehicle 20 (i.e., its left and right). In a preferred example, the set of sensors 104 are arranged to capture information to a rear of the vehicle 20; i.e., the roadway 10 being sensed is roadway that the vehicle 20 will have just travelled on/over. The set of sensors may be configured to capture information on the roadway surface from multiple sides of the vehicle simultaneously, thereby increasing an effective field of view of the sensors.

The apparatus 100 also comprises a communicator 120 configured to transmit the data relating to the roadway surface, captured by the set of sensors 104, to a server 200 (see FIG. 2). Communication is achieved via a suitable telecommunications network while the vehicle is in operation. That is, the sensor data relating to the roadway surface 10 is transmitted while the vehicle is being operated to traverse the road network of which the roadway surface 10 is a part (preferably vehicle operation means while the vehicle is moving, but also more broadly applies to while the ignition is on, and so may also include the vehicle being temporarily stopped at e.g., a traffic light). In this way the captured data may be suitably communicated to the server 200 for analysis in substantially real time, allowing for similarly real time analysis of the data to provide live updates of the surface condition of the road network. In the present examples the telecommunications network is envisaged as one of a 4G or 5G network (depending on network availability).

FIG. 2 shows a schematic flow diagram of the example apparatus 100 in more detail as part of a system for capturing, analysing, and reporting defects of a roadway surface 10. Here the system comprises a plurality of like configured apparatuses 100 (FIG. 2A) arranged to capture information on roadway surfaces, and provide that data to the server 200 (FIG. 2B) for analysis to detect roadway defects 12. The following however focuses on just a single apparatus 100.

Looking to FIG. 2A, the first sensor 106 preferably comprises/is a laser profilometer. Suitably, the laser profilometer 106 comprises a (profile) scanning laser 114 and an image sensor 116. Thus, preferably, the captured data relating to the roadway surface 10 comprises laser profilometry data captured by the image sensor 116 which is suitably configured to capture profile data based on reflection of radiation emitted by the scanning laser 114 from the road surface 10. The laser profilometry discussed herein is suitable for providing much higher resolution images, even while the vehicle is travelling at speed, compared to existing range finding (e.g., lidar) techniques.

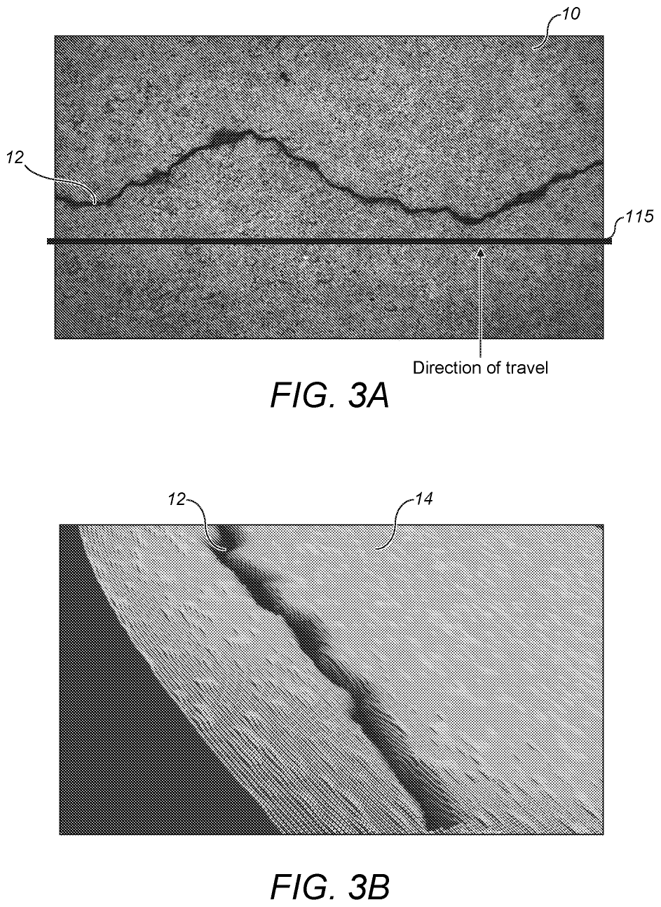

An example of laser profilometry in action to capture information on the road surface 10 is shown by FIG. 3. FIG. 3A shows an example road surface 10 comprising a crack 12 (more generally a road defect), while FIG. 3B shows an example image of a profiled surface 10 based on data captured by the image sensor 116. Here it can be seen that optical emission 115 from the scanning laser 114 travels along the road surface 10 as the vehicle 20 moves. The optical emission 115 is preferably in the form of a scanning line 115 with a length (thickness) in the direction of travel (locomotion) which is narrower than a width orthogonal to the direction of travel. Suitably the dimensions of the scanning line 115 determines a size of road defect 12 features that can be resolved by the profilometry; that is, a fineness or coarseness of the profilometer data.

Suitably in one example the length (thickness) of the line may be a range of 10 um (micrometre) to 10 mm (millimetre). Further preferably the length of the scanning line 115 may be in a range from 100 um to 5 mm. Yet further preferably the scanning line 115 may be a range from 500 um to 2 mm. In one particular example the length of the scanning line 115 is 1 mm, which has been found to provide a satisfactory trade-off between resolving road defects 12 that require fixing, ignoring random road micro structures, and allowing suitably swift data capture and analysis. The width of the scanning line 115 is suitably set based on the amount of road which is desired to be analysed concurrently. In one example, the width is in the range of 1 m (metre) to 10 m, the upper limit being designed to capture essentially two lanes of a carriageway. In a preferred example, the width is in the range of 2.5 m to 5 m, in order to capture substantially a single lane of carriageway. In one particular example the width is 3 m, being slightly wider than most vehicles the apparatus 100 is envisaged for use on and therefore intended to profile roadway surface 10 immediately in front of or behind the vehicle 20 (i.e., the road the vehicle 20 travels on).

The imaging sensor 116 captures an image (more generally, a sequence of images, or image frames) of the optical emission 115 reflected from the surface 10, the captured image data thereby representing one example of data relating to the roadway surface 10. Capturing repeated images of the optical emission 115 allows one to build a data set like that shown in FIG. 2B—i.e., scanned roadway surface data 14—which can be later analysed to identify and determine properties of the road defect 12. To make data analysis easier, it is preferred that the image sensor 116 is configured with a suitable magnification to correlate the pixel density of the image sensor to the size of the optical emission 115. That is, the image sensor 116 may be configured with a predetermined number of pixels on the image sensor 116 corresponding to a thickness (length) of the scanning line 115 generated by the scanning laser 114.

The scanning laser 114 is preferably configured to output optical emission 115 at near infrared wavelengths; preferably a wavelength in a range from 760 nm (nanometres) to 808 nm, inclusive, although wavelengths above 808 nm could be used if desired. Suitably, the image sensor 116 is similarly configured to observe these wavelengths while ignoring other wavelengths of light (e.g., by being provided with a suitable optical filter which attenuates, and preferably blocks, visible light). In this way, stray light is less likely to impact the collected data on the roadway surface 10, particularly sunlight, and also the apparatus 100 will not distract drivers of other nearby vehicles. There is also a balance to be considered between desiring a low laser power for the safety of pedestrians and other road users, but requiring a high laser power for suitable roadway scanning. In general, the scanning laser is configured to output a power of at least 500 mW (milliwatts), which provides sufficient laser power when the apparatus 100 is used during night time (i.e., dark) conditions. More preferably, the laser output power is at least 1.2 W (Watts), which allows the apparatus 100 to be used in weak daylight conditions. Yet further preferably the scanning laser 114 is configured to output a laser power of at least 2 W, which has been determined to strongly distinguish the profilometer scanning line 115 from sunlight (or at least, the infra-red parts of it) and also to provide suitably powerful reflection of the scanning line 115 from the road surface 10 even in wet conditions. Increasing the power significantly above 2 W is possible, but not preferred due to safety concerns. Suitably, in some examples, the laser output power may be adaptably configured based on current environment and light conditions.

In one example implementation the scanning laser 114 is continuous, with a resolution of the scanned roadway 14 (i.e., the distance between captured images of the optical emission 115) being related to the image capture rate (i.e., frame rate) of the image sensor 116.

In a preferred example, however, the laser profilometer 116 is configured to output pulsed optical emission 115. For example, the scanning laser 114 may be a pulsed (rather than continuous) laser. Thus, the resolution of the scanned roadway 14 (or put another way, the granularity of data on the scanned roadway 14) is determined by the frequency of pulsing of the scanning laser 114. Suitably the image sensor 116 may have a frame rate set to match the pulse frequency and be synchronised to the frequency of optical emission 115. Pulsed optical emission beneficially provides greater control over the data capture, and also reduces the average power requirements of the laser 114.

Continuing this preferred example, the pulse frequency of the optical emission 115 may be suitably determined by the current speed of the vehicle 20 (i.e., speed of locomotion). In this way the rate of data capture to build the laser profilometer data 14 of the roadway surface 10 may be varied in order to ensure an even distribution of profilometry data along the surface 10; that is, the rate of optical emission may be varied so that the spacing on the road surface 10 between subsequent optical emissions 115 is substantially the same. For example, for a desired scan separation of 1 mm at speeds up to ˜100 km/h (kilometres per hour)/62 mph (miles per hour), the data capture rate may be approximately 28 kHz (kilohertz). For a spacing of 3 mm to 5 mm, at speeds of up to ˜48 km/h/30 mph, the data capture rate may be approximately 10 kHz.

Thus it can be seen that the laser profilometry discussed herein may be performed. For example the laser profilometry may be configured (e.g., have its pulse rate suitably set) to operate at speeds between about 5 mph and about 10 mph, at speeds between about 10 mph and about 30 mph, for example between about 15 mph and about 25 mph, and at speeds between about 30 mph and about 60 mph, for example between about 40 mph and about 50 mph, as well as other ranges in between, connecting, or overlapping the values listed here. It will also be appreciated that the laser profilometer may be suitably configured to operate at these sorts of speeds even in continuous mode, with the effective pulse frequency not being the frequency of the laser, but frequency of data reading.

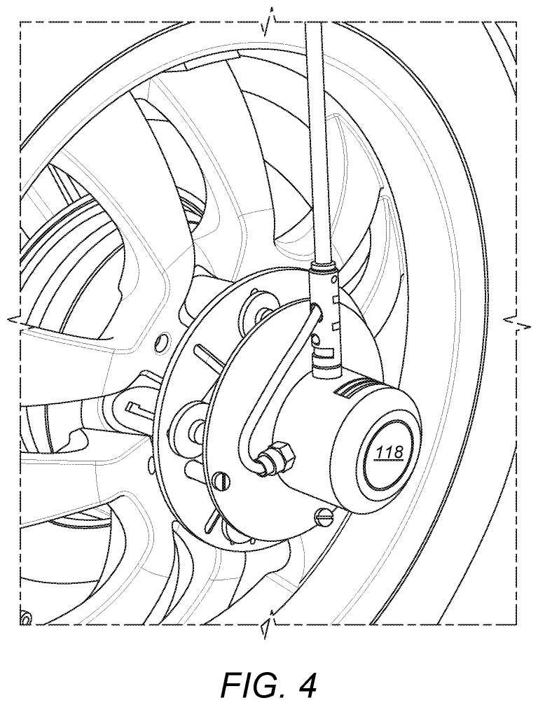

In a preferred example, the apparatus 100 comprises a dedicated speed encoder 118 such as shown in FIG. 4. The speed encoder 118 comprises means to mount the encoder 118 to the vehicle's wheel 22 (preferably in a fashion that maintains the orientation of the encoder 118 with respect to the vehicle chassis) and is coupled to the laser profilometer 106. The encoder 118 is configured to determine the speed of the vehicle 20 based on the wheel rotation. Suitably the laser profilometer 106—i.e., the pulse rate of the scanning laser 114 and optionally image capture rate of the image sensor 116—may be suitably controlled based on the speed of the vehicle 20 as determined by the encoder 118. Put another way, the encoder 118 controls the operating pulse frequency of the scanning laser 114 and pulse rate of the optical emission 115 based on its determination of the speed of the vehicle 20. Alternative options for determining vehicle speed include coupling the apparatus 100 to the vehicles speedometer, or to a GPS system (either dedicated or from a third party device), however such techniques are generally not as accurate as the dedicated speed encoder 118 approach, and also require more complicated setup for the apparatus 100 (e.g., to connect the apparatus 100 to the vehicle electronics).

Relatedly, it will be appreciated that the speed encoder 118 (or other speed measure) may also determine that the speed of the vehicle is zero—i.e., the vehicle is not in motion: for example, when the vehicle 20 is stopped at a traffic light. In this case the laser profilometer 106 may be suitably controlled to deactivate the scanning laser 114, or the pulse rate of the scanning laser 114 may set to zero (if left in a standby mode rather than fully deactivated), when it is determined that the vehicle 20 is stopped. It will be appreciated that when the vehicle 20 is stopped is when there is a greater likelihood of pedestrians and cyclists being in close proximity to the vehicle 20, and so the scanning laser 114 may be suitably deactivated in this scenario to increase safety of the apparatus 100 and reduce potential exposure of a pedestrian to direction laser emission.

As an additional safety feature, the scanning laser 114 may also be deactivated if there is a ever a loss in connection between the scanning laser 114 and the speed encoder 118 (or other speed estimators). That is, the laser profilometer 106 may be configured to be activated only when a suitable signal is being received form the speed encoder 118 (or other speed estimators), and if no signal is being received, then the laser profilometer 106 (and in particular the scanning laser) will stay deactivated. In some examples, an indicator may be provided on the apparatus 100 to show a user that the speed encoder 118 is not connected.

Returning to FIG. 2A, in this example the second sensor 108 of the set of sensors 104 comprises a colour camera (e.g., a red-blue-green, RGB, camera) to capture colour images of the roadway surface 10. In particular, the colour camera 108 is configured to capture colour images of the roadway surface 10 which mutually corresponds to a field of view of the first sensor 106 (that is, corresponding to the field of view of the profilometer 106, preferably its image sensor 116). In the present examples, data from the colour camera 108 is envisaged as providing useful data for reporting purposes and quality control, but in some examples may also be analysed alongside data from the first sensor 106 to detect roadway defects 12.

The third sensor 110 of the set of sensors comprises a global positioning system (GPS) which provides location information related to the roadway surface. In some examples the third sensor may be used instead of a speed encoder to provide speed information of the vehicle relevant to controlling the first sensor 106.

In another example (not shown in FIG. 2), a fourth sensor 112 of the set of sensors comprises at inertial measurement unit (IMU) which captures deviations in vehicle movement caused by the road surface 10; this data can be used to compensate aberrations in data collected by other sensors in the set of sensors resulting from e.g., bumps in the road.

In addition, the IMU (fourth sensor 112) may be configured to determine an inclination of the apparatus 100 (with respect to a nominal “horizontal”). Suitably, if the IMU determines that the inclination of the apparatus 100 is above a certain threshold—e.g., 30 degrees—then a ‘turn off’ control signal may be communicated to the laser profilometer 106 in order to deactivate the scanning laser. Alternatively, the signal may be communicated to a main controller of the apparatus 100 (e.g., a processor) which in turn may control to deactivate all of the various components of the apparatus 100. In this way the apparatus (and principally the scanning laser 114) may be deactivated if the vehicle is in an incident in which it ends up on its side, thereby preventing accidental radiating of people nearby (who may be e.g., coming to emergency aid).

Optionally, further sensors can be added to the apparatus 100 which do not specifically capture roadway information, but instead information on an environment in which the vehicle 20 is travelling. For example, the apparatus 100 may include a 360-degree camera to capture above ground roadside assets such as lights, barriers, road signs etc. In another example, the additional sensors may include radar for detecting below-the-ground-structural problems.

Suitably, the apparatus 100 also comprises a memory 122 and at least one processor 124. The processor 124 is configured to compile data captured by the set of sensors 104 into correlated segments of data 126 based on a timestamp of when the data is captured. Preferably the segment of data 126 is transmitted via the communicator 120 as soon as it is compiled, in order to provide real time data to the server. In some situations, the processor 124 may instead store the segmented data 126 in the memory 122 in preparation for transmission, and then later control the communicator 120 to transmit each segment of data 126 in turn based on the timestamp. In other words, the processor may queue the data ready for transmission. Such a system may allow for still substantially real time transmission, but may be particularly beneficial where a speed and/or signal strength of the telecoms network is irregular. In some examples, substantially real time (or near real time) may be taken to be preferably within 1 minute of data collection, in some examples up to within 10 minutes, some examples within 20 minutes, and some examples within 30 minutes. Furthermore, in order to clear storage space, the compiled segmented data may be deleted from the memory 120 after the communicator 120 has confirmed transmission of the data packet.

In some examples, the apparatus 100 may also comprise a system health monitor 128, suitably coupled (or part of) the processor 124. The health monitor 128 may be configured to determine operability of the apparatus 100 by, inter alia, checking an operability of the set of sensors 104. Checking the operability of the set of sensors 104 may comprise checking alignment of the first sensor (laser profilometer) 106 to the second sensor (RGB camera) 108, and in some cases checking an alignment of the scanning laser 114 to the image sensor 116. Checking the alignment is beneficial because misalignment can readily happen within the apparatus due to e.g., thermal effects arising from changes in temperature during day/night when the apparatus is stored (it is expected that the apparatus 100 will often be left attached to a vehicle, despite having the ability to dismount to the apparatus 100 and store it safely in a controlled environment). Checking operability may also comprise checking other parameters, for example temperature inside the apparatus 100. This may avoid the components being activated when there is a risk of overheating.

FIG. 2B shows an example arrangement of the server 200. The server 200 is configured to analyse the data relating to the roadway surface 10 captured by at least one sensor 104 of the vehicle mounted apparatus 100 during locomotion of the vehicle, and report detected defects of the roadway surface.

The server comprises at least one transceiver 202 configured to receive the data 126 relating to the roadway surface 10 captured by the sensors 104 of the (vehicle mounted) apparatus 100; as just discussed, the data 126 having been collected during locomotion of the vehicle 20 and transmitted while the vehicle 20 is in operation. The server 200 may also comprise suitable circuitry to communicatively couple the server 200 to a display device (via e.g., the same transceiver 202 or a different communicator).

The server also comprises at least one processor 204 configured to process/analyse the received data 126 relating to the roadway surface 10 (substantially in real time as the data 126 is received) to identify received data corresponding to a defect 12 and to determine parameters of the defect 12 based on that data. Preferably such parameters are dimensions of the defect 12, and so the determined parameters may include one or more of length of the defect 12 (e.g., in the direction of the profilometer 106 scan), width of the defect 12, and depth of the defect 12. Such parameters may be readily derived from (i.e., measured from) certain sensor data such as the laser profilometer data. In some examples, the determined parameters may also include parameters which are more subjective in nature, including for example one or more of an estimated severity (based on e.g., possible damage to a vehicle) and/or a likelihood of the defect 12 to deteriorate.

In one example the step of identifying data with a defect and the step of identifying parameters of the defect is procedural. Here the received data 126 is first pre-analysed to identify if the received data 126 comprises a defect 12, for example by determining whether a deviation in the observed profilometer's scanning line 115 deviates by more than a threshold amount from an expected normal (that is, a calibrated non-deviated amount). Data so identified as having a possible defect 12 is then flagged for further analysis to determine the relevant parameters of the defect, e.g., by measuring length/width/depth of the defect 12 based on the laser profilometer data.

In a preferred example the steps of identifying a defect and determining the parameters of the identified defect are performed substantially simultaneously. More specifically, it is envisaged that the step of identifying defects and determining their parameters may be performed by a machine learning model 212. Suitably, a classifier type machine learning model 212 may be trained based on data from at least one sensor in the set of sensors 104 to identify the presence of a defect in the sensor data, and optionally classify different types of defect; e.g., cracks or holes. The same model may be suitably trained to also generate the relevant parameters of the defect. Using a suitably trained machine learning model allows for the data analysis to be performed much quicker than doing so via procedural means.

It will be appreciated from the above discussion that the sensor data on which the machine learning model is trained includes at least the profilometry data captured by the profilometer image sensor 116. That is, data such as that shown in FIG. 3B. Suitably, at inference, profilometry data (e.g., FIG. 3B) is provided as input to the machine learning model which then identifies, classifies, and determines parameters of a defect and outputs that result data.

The machine learning model may also be trained using a combination of laser profilometry data and data from at least one other sensor. In particular, in some examples it may be desirable to provide, as an input to the machine learning model, a combination of laser profilometer 106 data and RGB camera 108 data from within the same data segment 126. In this way the RGB camera data may be utilised for more robust defect identification, and may also allow for easier training of the model due to a greater abundance of RGB pictures of potholes, etc, while still allowing for determination of relevant defect parameters via the profilometry data. In this case, while functionally the processing is still performed as a combined step (i.e., one combined data input is provided to the machine learning model), it may be conceptually considered that the identification and parameter steps are still separate due to the ability to base the output on the different input (or, indeed, two separate machine learning models may be run, one taking RGB camera data as input, one taking laser profilometry data as input).

Once a defect has been analysed (i.e., identified and parameterised), the analysed data is stored in a storage 206. More specifically, information relating to the identified defect, including the determined parameters, is stored in the storage 206. Here, the general information relating to the defect includes at least one or a combination of data collected by the set of sensors 104—e.g., first sensor 106 data, second sensor 108 data, and third sensor 110 data—and optionally the timestamp data. In other words, the information relating to the identified defect may include a combination of the data 126 which was transmitted to the server at the same time as the profilometer data in which the defect was identified. In a preferred example, the information relating to the defect (i.e., that is stored in the storage 206) comprises at least the GPS 110 data and RGB camera 108 data (in addition to the determined defect parameters).

The processor 204 is then configured to transmit the stored data (i.e., information relating to the identified defect, including the determined parameters) to a display device 300 communicatively coupled to the server 200. That is, the server 200 is communicatively coupled to the display 300 so that the analysed data may be retrieved and/or viewed (e.g., by the same transceiver 202, or different communication circuitry). In this way, information relating to the identified defect, including the determined parameters, is reported in substantially real time to a user via a user interface displayed on a suitable computing device (provided that the user interface is in use at that time).

In a preferred example, transmitting the information relating to the identified defect includes transmitting the data over the internet, such that the information is viewable using a suitable user interface 208. That is, the user interface 208 is part of a suitable application programming interface (API) 210 of the server 200 which allows the display 300 to show the information stored in the storage 206. In other words, the server 200 and display 300 preferably operate in a typical server to client relationship, where the server 200 transmits the information relating to the defect in response to a request from the display 300 acting as a client. It will be appreciated that the information stored in the storage may be made accessibly only after suitable authentication, which may also be provided as part of the user interface 208.

In another example, transmitting the stored data may be achieved without first requiring a request from a client device. For example, the information relating to identified roadway defect may be transmitted to a known external device (which could be another server), stored locally, and then viewed using a user interface provided on a display of the external device.

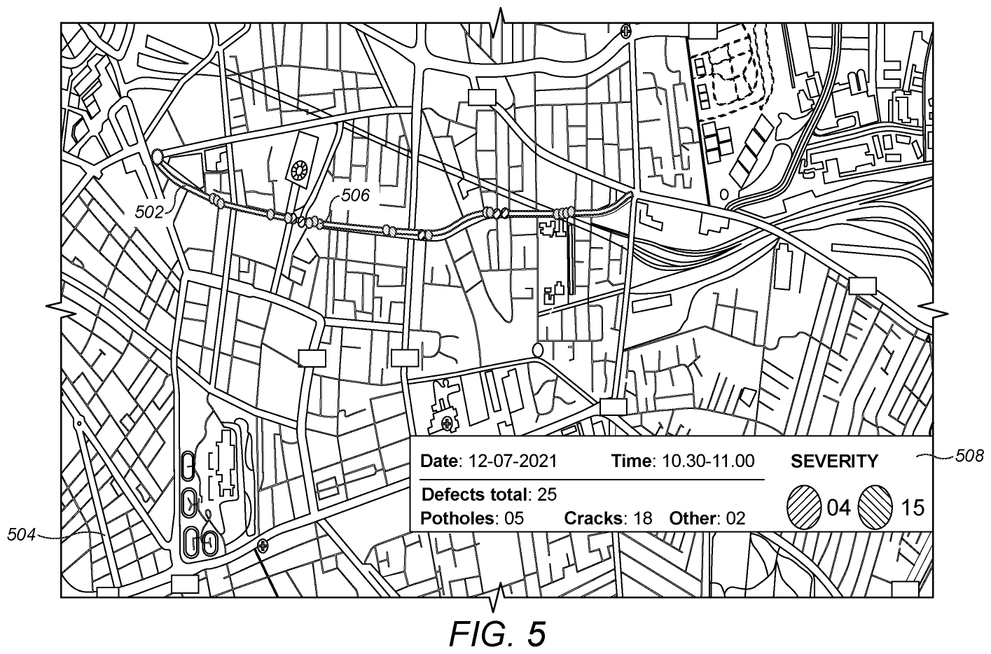

An example user interface is shown in FIG. 5, which shows a route 502 of a vehicle 20 on an area of road network 504; that is, the route 502 shows the road surfaces 10 along which the vehicle 20 has travelled and which have been scanned by an apparatus 100 mounted to the vehicle 20. Indicators 506, here shown as dots, although the exact form is variable, show where along the route 502 defects in the road surface have been identified; that is, where along the route 502 has data captured by the first sensor 106 (laser profilometer) been identified as comprising a defect. The location of the indicators 506 may be based on e.g., GPS data captured by the third sensor 110. A window 508 shows information related to the route 502, summarising a time over which the data was collected, the types of defects encountered, and their severity. Information related to a specific one of the indicators 506—i.e., the information related to the roadway defect associated with that marker 506, and the determined parameters of the defect, amongst other data—may be seen by clicking on an individual marker 506. The information provided in FIG. 5 may be used to manually dispatch repair crews and the like to a roadway defect requiring repair, or the data may be used to automatically achieve such an aim (although the automatic provision of a repair schedule, and any apparatuses used therein, are not the focus of this application).

As an alternative to the apparatus 100/server 200 arrangement shown in FIG. 2, in one embodiment the analysis of data captured by the one or more sensors 104 may be performed on the apparatus side rather than the server side. Suitably, in this example, the at least one processor 124 may be configured to (in addition to its other functions) analyse the captured data relating to the roadway surface to identify data corresponding to a defect of the roadway, and to determine parameters of the defect based on the identified data, and control the communicator 120 to transmit, while the vehicle is in operation, information on the identified roadway defect, including the determined parameters, to a remote server. The functioning of the remainder of the apparatus 100, and the way in which the data is analysed, may be the same as substantially already described above.

Although the above has been described in relation to roadway surfaces it will be appreciated that the techniques may be readily adapted to facilitate identifying defects on other types of surfaces that a vehicle may travel along or nearby too.

For example, instead of a roadway surface, the apparatus may be used to scan the surface of a mega ship, or an airport runway, (which are both substantially just a different type of road) while a suitable vehicle traverses the megaship/runway.

In a different example, the apparatus may be configured for use in a tunnel, so that the set of sensors are suitably configured to capture data relating to the tunnel surface of the tunnel enclosure to the sides or even above the vehicle as it travels through the tunnel (i.e., the apparatus does not necessarily need to be used to scan a road that the vehicle travels on, but a suitably nearby surface).

In yet another example, the set of sensors may be suitably configured to capture information on the surface of a dam wall (i.e., the surface of the dam on the non-water side of the water retaining wall), with the vehicle being suitably configured to traverse up and down the dam wall.

Also, while the above has focused on the first sensor for capturing roadway surface information being a laser profilometer (and subsequently analysing that profilometry data), it will also be appreciated that other techniques for capturing pothole data and determining pothole parameters may be used. In one alternative example, the RGB camera may be the first sensor, with sizes of detected potholes being determined using known optics equations based on a pre-set/calibrated distance of the apparatus to the roadway surface and a known field of view and focal length of the camera, in combination with a machine learning algorithm to identify the presence of the potholes in the first place. In another alternative example, the first sensor may include a suitably configured Lidar apparatus.

It will be appreciated that in the above alternative examples the remaining operations of the apparatus 100 (and corresponding server 200) may be the same as already described.

In summary, exemplary embodiments of an apparatus, server, and improved technique for finding roadway defects have been described. The described exemplary embodiments provide for collection and analysis of road surface data in real time and to do so safely with at a tuneable rate of data collection. Use of a machine learning algorithm in the data analysis greatly improves the ability for the system to provide real time updates on road surface defects. The data reported from the present system (e.g., output by the machine learning model) may be provided to other, similar, systems which control dispatch of repair crews and/or specialist automated pothole repair equipment to a relevant site.

The present embodiments may be manufactured industrially. An industrial application of the example embodiments will be clear from the discussion herein. Additionally, the described exemplary embodiments are convenient to manufacture and straightforward to use.

At least some of the example embodiments described herein may be constructed, partially or wholly, using dedicated special-purpose hardware, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

At least some of the example embodiments may make use of computer program code. Such code may be provided on a carrier such as a disk, a microprocessor, CD- or DVD-ROM, programmed memory such as non-volatile memory (e.g., Flash) or read-only memory (firmware), or on a data carrier such as an optical or electrical signal carrier. Code (and/or data) to implement embodiments described herein may comprise source, object, or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

At least some of the example embodiments may be implemented using an AI model. A function associated with AI may be performed through non-volatile memory, volatile memory, and a processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

Although preferred embodiment(s) of the present invention have been shown and described, it will be appreciated by those skilled in the art that changes may be made without departing from the scope of the invention as defined in the claims.

Attention is directed to all papers and documents which are filed concurrently with or previous to this specification in connection with this application and which are open to public inspection with this specification, and the contents of all such papers and documents are incorporated herein by reference.

All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification, or to any novel one, or any novel combination, of the steps of any method or process so disclosed.

1. An apparatus for capturing information on roadway surfaces, comprising:
a mount for attaching the apparatus to a vehicle;
a set of sensors, including a first sensor, configured to capture data relating to a roadway surface proximate to the vehicle, during locomotion of the vehicle; and
a communicator configured to transmit the captured data relating to the roadway surface to a remote server, via a telecommunications network, in real-time;
wherein the first sensor comprises a laser profilometer comprising a scanning laser and an image sensor, and wherein the data relating to the roadway surface, captured during locomotion of the vehicle, includes laser profilometry data of the roadway surface.

2. The apparatus of claim 1, wherein the scanning laser is configured to operate at a wavelength in a range from 760 nanometres to 808 nanometres.

3. The apparatus of claim 1, wherein the image sensor comprises an optical filter configured to attenuate visible light.

4. The apparatus of claim 1, wherein the scanning laser is configured to operate at an output power in a range from 0.5 Watts to 2 Watts, inclusive.

5. The apparatus of claim 1, wherein the laser profilometer is configured to generate pulsed emission from the scanning laser.

6. The apparatus of claim 5, wherein the laser profilometer is configured to control a pulse frequency of the pulsed emission based on a speed of locomotion of the vehicle.

7. The apparatus of claim 6, further comprising a speed encoder mounted to a wheel of the vehicle and configured to determine the speed of locomotion of the vehicle, wherein the speed encoder is electrically coupled to the laser profilometer, and wherein the laser profilometer is configured to control the frequency of pulsing of the optical emission based on the locomotion speed of the vehicle as determined by the speed encoder.

8. The apparatus of an claim 1, wherein the laser profilometer is configured to deactivate data capture when the vehicle is not in motion.

9. The apparatus of claim 1, wherein a predetermined number of pixels of the image sensor of the laser profilometer corresponds to a thickness of a scanning line generated by the scanning laser.

10. The apparatus of claim 1, wherein the scanning laser is arranged to generate a scanning line having a length in a direction of travel of the vehicle in a range from 10 urn to 10 mm, preferably in a range from 100 urn to 5 mm, more preferably in a range from 500 pm to 2 mm, for example 1 mm, and a width orthogonal to a direction of locomotion of the vehicle in a range from 1 m to 10 m, preferably in a range from 2.5 m to 5 m, for example 3 m.

11. The apparatus of claim 1, wherein the set of sensors includes a colour image sensor configured to capture colour images of the roadway surface.

12. The apparatus of claim 11, wherein respective fields of view of the colour image sensor and the image sensor of the laser profilometer mutually correspond.

13. The apparatus of claim 1, wherein the set of sensors includes a global positioning system, GPS.

14. The apparatus of claim 1, wherein the set of sensors includes an inertial measurement unit, IMU.

15. The apparatus of claim 1, further comprising:
a memory, and
a processor configured to generate segmented data from the data captured by the set of sensors based on a timestamp of when the data was captured, store the segmented data in the memory, and control the communicator to transmit each segment of the segmented data in turn based on the timestamp.

16. A server configured to analyse data relating to a roadway surface captured by a set of sensors of a vehicle mounted apparatus during locomotion of the vehicle, the set of sensors comprising a laser profilometer, and report detected defects of the roadway surface, the server comprising:
a transceiver configured to:
receive, in real time, the data relating to the roadway surface captured by the set of sensors of the vehicle mounted apparatus during the locomotion of the vehicle, wherein the data relating to the roadway surface comprises laser profilometer data, and
communicatively couple the server to a display device; and
at least one processor configured to:
analyse the received data relating to the roadway surface including the laser profilometer data, in real time as the data are received, to identify received data corresponding to a defect of the roadway surface, and to determine parameters of the defect based on the identified data; and control the communicator to transmit information related to the defect of the roadway surface, including the determined parameters, to the display device.

17. The server of claim 16, wherein determining parameters of the defect based on the identified data comprises classifying the defect using a machine learning model.

18. A system comprising:
an apparatus for capturing information on roadway surfaces, comprising
a mount for attaching the apparatus to a vehicle;
a set of sensors, including a first sensor, configured to capture data relating to a roadway surface proximate to the vehicle, during locomotion of the vehicle; and
a communicator configured to transmit the captured data relating to the roadway surface to a remote server, via a telecommunications network, in real-time;
wherein the first sensor comprises a laser profilometer comprising a scanning laser and an image sensor, and wherein the data relating to the roadway surface, captured during locomotion of the vehicle, includes laser profilometry data of the roadway surface; and
a server configured to analyse data relating to a roadway surface captured by a set of sensors of a vehicle mounted apparatus during locomotion of the vehicle, the set of sensors comprising a laser profilometer, and report detected defects of the roadway surface, the server comprising:
a transceiver configured to:
receive, in real time, the data relating to the roadway surface captured by the set of sensors of the vehicle mounted apparatus during the locomotion of the vehicle, wherein the data relating to the roadway surface comprises laser profilometer data, and
communicatively couple the server to a display device; and
at least one processor configured to:
analyse the received data relating to the roadway surface including the laser profilometer data, in real time as the data are received, to identify received data corresponding to a defect of the roadway surface, and to determine parameters of the defect based on the identified data; and control the communicator to transmit information related to the defect of the roadway surface, including the determined parameters, to the display device.
